(19) United States
(12) Patent Application Publication
(10) Pub. No.: US 2016/0129993 A1
(43) Pub. Date: May 12, 2016

(54) AIRCRAFT WING FOR RECEIVING A PLURALITY OF DIFFERENT WING TIP DEVICES

(71) Applicant: AIRBUS OPERATIONS LIMITED, Bristol (GB)

(72) Inventors: Jonathan DEE, Bristol (GB); Matthew Noel ORCHARD, Bristol (GB)

(21) Appl. No.: 14/933,126

(22) Filed: Nov. 5, 2015

(30) Foreign Application Priority Data
Nov. 12, 2014 (GB) 1420102.4

(51) Int. Cl. B64C 23/06; G06Q 30/06; G06F 17/50; B64C 3/38

(52) U.S. Cl. CPC B64C 23/065; B64C 3/38; G06Q 30/0641; G06F 17/5095

(57) ABSTRACT

An aircraft wing, the wing having a connection interface at the tip of the wing, and the wing being configurable between a first configuration in which a first wing tip device is connected to the connection interface, and a second configuration in which a second wing tip device is connected to the connection interface to replace the first wing tip device. The design of the wing is such that it is designed for performance in both the first and the second configurations.

### BACKGROUND OF THE INVENTION

The present invention relates to aircraft wings, and more particularly to aircraft wings for receiving a plurality of different wing tip devices, and to methods of designing such wings and/or wing tip devices.

It is well known to use wing tip devices (such as winglets, tip fences, planar extension etc.) on aircraft wings. Wing tip devices may be retro-fitted to existing wings, or incorporated into a new aircraft wing as part of the initial design process.

When designing a new aircraft wing, the wing tends to be designed specifically for use with a particular wing tip device. Thus the wing is designed for performance with the wing tip device fitted.

When retro-fitting a wing tip device, the wing to which the device is to be fitted has usually been previously designed for performance without a wing tip device, thus some modification of the wing may be required (e.g. structural reinforcement to cope with different structural loading). The new wing tip device may, alternatively, replace an existing wing tip device on the wing. In this case, the wing has usually been previously designed for performance with the original wing tip device fitted.

By way of example, a known aircraft was originally designed with a wing having a wingtip fence connected at the wing tip. Later in the life of that aircraft, the wingtip fence was replaced by a winglet. The winglet was found to provide reduced fuel consumption on a given mission profile, in comparison to the wingtip fence. To cope with the structural loadings caused by the replacement of the wingtip fence with the winglet, the aircraft wing design was modified. This modified wing design was (re-) designed for performance with the winglet fitted. The (re-) designed wing design comprises a connection interface at the tip of the wing, enabling the wing to receive either the winglet or the wingtip fence (it may be necessary to replace the winglet with the fence in the event of damage to the winglet for example).

The above-mentioned aircraft thus provides a wing design that is designed for when the winglet is fitted, but is sub-optimal for when the wingtip fence is fitted. Thus, whilst the wingtip fence can still be used on the aircraft wing, that wing is heavier than it would ideally need to be.

### SUMMARY OF THE INVENTION

According to a first aspect of the invention, there is provided an aircraft wing, the wing having a connection interface at the tip of the wing, and the wing being configurable between a first configuration in which a first wing tip device is connected to the connection interface, and a second configuration in which a second wing tip device is connected to the connection interface to replace the first wing tip device, characterised in that the wing is designed for performance in both the first and the second configurations.

By providing a connection interface capable of receiving both the wing tip devices, and designing the wing design for performance in both the first configuration and the second configuration, the present invention provides a wing that can readily be used with either the first or the second wing tip device. This means the functionality of the same basic aircraft (to which such a wing is fitted) can be readily modified simply by changing the wing tip device that is connected to the wing, and without necessarily requiring any other re-engineering of the wing. This not only gives the aircraft operator more flexibility in how to use the aircraft, but also increases the potential re-sale value of the aircraft because that flexibility is also available to later operators of the aircraft. In effect, the present invention provides a wing that does not necessarily have optimal performance in either the first or second configuration, but is designed to work very well in both configurations; any reduction in performance in the first or second configuration, is outweighed by the increase in flexibility offered by such an arrangement.

The first wing tip device is different to the second wing tip device. For example the first and second wing tip devices may be different shapes, or even different types of wing tip device. The first wing tip device is preferably designed for use during a first mission profile. The second wing tip device is preferably configured for use during a second mission profile. The first and second mission profiles are different. For example, the first mission profile may be a long-range mission, whereas the second mission profile may be a short-range mission. For the first mission profile, a long-span winglet may be appropriate because it increases the effective aspect ratio of the wing and reduces cruise drag. For the second mission on the other hand, a lightweight blended winglet may offer more efficiency gains. The present invention enables the same basic aircraft wing to be used for either mission by simply attaching the appropriate wing tip device to the wing.

It will be appreciated that reference to a mission profile need not relate to a military mission. Indeed, the mission profile is preferably for a commercial passenger aircraft. The mission profile may be defined in a number of ways. The mission profile may include a range. The mission profile may include a cruise speed. The mission profile may include an altitude, for example a cruise altitude. The mission profile may include other variables such as operating constraints for the aircraft. For example, the mission profile may include gate limits faced by the aircraft, and the span of the wing tip device used could be maximised for the available gate limits.

The design of the wing is designed for performance in both the first configuration and the second configuration. It will be appreciated that in each one of these configurations, the wing design may be sub-optimal, however the present invention recognises that by designing for both configurations a better balance of performance can be achieved (in comparison to purely optimising for one configuration as per the prior art). This, in turn enables the advantages of having interchangeable wing tip devices to be more-fully realised.

Wing design is typically a balance between structural and aerodynamic considerations. The aerodynamic characteristics of the wing may have been designed for performance in both the first configuration and the second configuration. The structural characteristics of the wing may have been designed for performance in both the first configuration and the second configuration. Both the structural and the aerodynamic characteristics of the wing may have been designed for performance in both the first configuration and the second configuration.

The connection interface is configured to receive the first and the second wing tip device. The connection interface may be configured to receive a multiplicity of different wing tip devices. Providing a common connection interface is especially advantageous in enabling the wing tip devices to be readily changed.

The wing may be configurable between a multiplicity of configurations in which a different respective wing tip device is connected to the connection interface to replace the previous wing tip device. The wing may be designed for performance in all the multiplicity of configurations.

According to another aspect of the invention, there is provided a method of designing a wing for an aircraft, the wing having a connection interface at its tip for receiving a plurality of different wing tip devices, and the wing being configurable between a first configuration in which a first wing tip device is connected to the connection interface, and a second configuration in which the first wing tip device is replaced by a second wing tip device connected to the connection interface, wherein the method comprises the step of designing the wing for performance in both the first configuration and the second configuration. By designing the wing such that it is designed for performance in both the first configuration and the second configuration, the functionality of the same basic aircraft (to which such a wing may be fitted) can be readily modified simply by changing the wing tip device that is connected to the wing.

The method may comprise the step of designing the wing for the aircraft flying a first mission profile in the first configuration, and for the aircraft flying a second mission profile in the second configuration.

The method of designing may be a method of re-designing an existing wing design. When re-designing an existing wing, the method may comprise the step of modifying the existing wing to the re-designed specification.

The above-mentioned aspects of the invention provide a wing that is designed for two different configurations of wing tip device. It has also been recognised that it may also be desirable to provide a wing tip device that is designed for a particular wing. According to another aspect of the invention there is provided a method of designing a wing tip device for an aircraft wing, the aircraft wing having redundant structural margins, wherein the method comprises the steps of designing the wing tip device such that when the wing tip device is attached to the wing, at least some of the redundant structural margins of the wing are used during flight of the aircraft. This aspect of the invention recognises that a wing may have redundant structural margins (for example redundant structural capacity that has arisen due to the existence of other aircraft components and their influence on the wing structure), and that those can be used by appropriately tailoring the wing tip design. For example the lift distribution, sweep or other characteristics of the wing tip device may be tailored to make use of the otherwise redundant structural margins.

The above-mentioned method may be used as a stand-alone method of designing a wing tip device for a pre-existing wing. More preferably, the method is used as part of a method of designing a wing according to another aspect of the invention. For example, in a method of designing described herein, the wing may be designed as part of an iterative process in which both the wing and winglet are designed in tandem.

The step of designing the wing tip device may comprise (i) calculating aerodynamic performance of an initial design of the wing tip device; (ii) calculating the structural loads created by the wing tip device in use; (iii) calculating the use of the redundant structural margins, by the loads in step (iii); and (iv) iteratively repeating steps (i) to (iii) for variants of the initial design of wing tip device, until a final design of wing tip device is reached.

According to yet another aspect of the invention there is provided a method of preparing an aircraft for sale, the method comprising (i) offering an aircraft for sale, the aircraft having a wing with a connection interface at the tip thereof (ii) offering a customer a plurality of different wing tip devices for connection to the connection interface, each wing tip device being designed for use in a respective mission profile, and (iii) receiving a selection from the plurality of wing tip devices, from the customer. The method may further comprise the step of (iv) connecting the selected wing tip device to the connection interface of the wing.

According to yet another aspect of the invention there is provided a method of providing increased functionality of an aircraft, the method comprising having a wing of the aircraft configured in a first configuration in which a first wing tip device is connected to a connection interface at the tip of the wing, the first configuration being for use during a first mission profile, identifying a second mission profile, and modifying the wing to a second configuration in which the first wing tip device is replaced by a second wing tip device connected to the connection interface, the second configuration being for use during the second mission profile

According to yet another aspect of the invention there is provided an aircraft wing configurable between a first configuration for use during a first mission profile, and a second configuration for use during a second mission profile wherein the wing has a connection interface at the tip of the wing and in the first configuration a first wing tip device, for use during the first mission profile, is connected to the connection interface, and in the second configuration, the first wing tip device is replaced by a second wing tip device, for use during the second mission profile, connected to the connection interface. By providing interchangeable wing tip devices for different mission profiles, the flexibility of use of the aircraft may be increased.

According to yet another aspect of the invention there is provided an aircraft comprising the aircraft wing described herein.

Any features described with reference to one aspect of the invention are equally applicable to any other aspect of the invention, and vice versa.

### DESCRIPTION OF THE DRAWINGS

Embodiments of the present invention will now be described by way of example only with reference to the accompanying schematic drawings of which:

FIG. 1 shows an aircraft according to a first embodiment of the invention;

FIGS. 2a and 2b are schematics showing part of a wing of the aircraft in FIG. 1 in two different configurations;

FIG. 3 is a flowchart showing a method used to design the wing of the aircraft in FIG. 1;

FIG. 4 is a flowchart showing a method according to a second embodiment, by which a wing tip device is designed.

### DETAILED DESCRIPTION

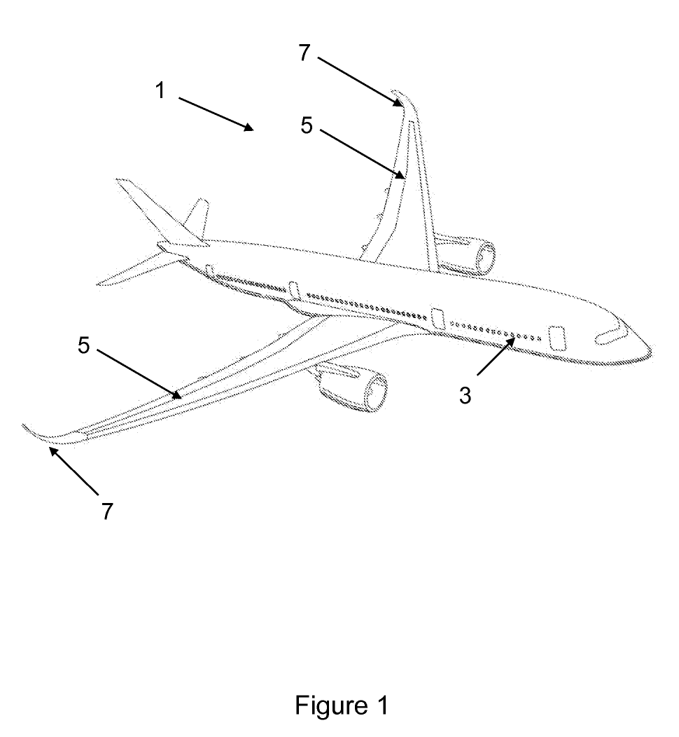

FIG. 1 shows a passenger aircraft 1 according to a first embodiment of the invention. The aircraft 1 comprises a fuselage 3 and wings 5. Each wing 5 has a winglet 7 mounted at its tip. As is well known in the art, the winglet 7 can improve the aircraft performance, particularly is relation to a reduction in induced drag.

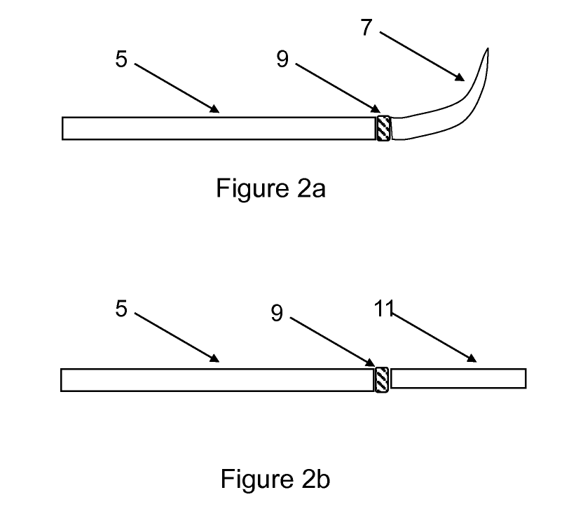

The winglet 7 attaches to its respective wing 5 at a wing-box-to-wing-tip connection interface 9 (not visible in FIG. 1 but see FIGS. 2a and 2b). In the first embodiment of the invention, the connection interface 9 is arranged to receive two different wing tip devices: the winglet in FIGS. 1 and 2a, and the planar wing tip extension 11 shown in FIG. 2b. By providing a common connection interface 9 arranged to receive the two different wing tip devices 7, 11 it is possible for different wing tip devices 7, 11 to be installed on the wing, depending on what device 7, 11 is most suitable for a particular mission profile. This enables the aircraft 1 to be relatively flexible in its use. For example the aircraft 1 may be operated on a medium-range mission profile with the winglet 7 fitted (i.e. with the wing 5 in a first configuration), because that winglet 7 gives the best performance over that profile. However, the aircraft 1 may alternatively be operated on a long-range mission profile with the wing tip extension 11 fitted (i.e. in a second configuration), because that wing tip device 11 gives the best performance over that longer profile. This flexibility in the aircraft's use may be attractive to airlines.

In principle, it would be possible to use the above-mentioned common connection interface 9 on an existing aircraft wing. However, that wing will have been designed for use either without a wing tip device fitted at all, or with a specific wing tip device fitted. If a different type of wing tip device were to be fitted (e.g. the planar extension 11 of FIG. 2b), the wing would not have been designed for performance with that new tip device. This may limit the magnitude of any benefits obtainable through use of the new wing tip device.

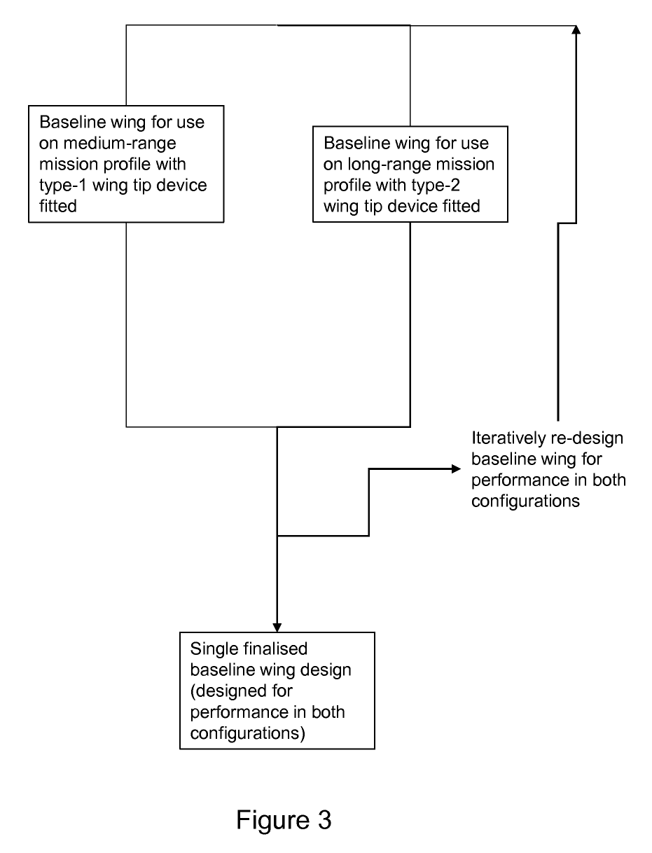

The wings 5 of the aircraft in FIG. 1 has been designed using a novel method according to an embodiment of the present invention. That method is described in the flowchart in FIG. 3, to which reference is now made.

The method starts from a first initial wing design for use in a first configuration with a type-1 wing tip device (i.e. the winglet 7) fitted, and a second initial wing design for use in a second configuration with a type-2 wing tip device (i.e. the wing extension 11) fitted. The method comprises iteratively re-designing these initial wings (the loop on the right-hand side of FIG. 3) to arrive at a common design in which the wing is designed for performance with the type-1 and the type-2 wing tip devices fitted. This iterative design process also takes into account the different mission profiles the aircraft would fly with the respective wing tip device fitted (medium- and long-range respectively).

Thus, whilst in each configuration in isolation the wing design may be sub-optimal, the present invention recognises that by designing for performance in both the first and second configurations, the final wing design achieves a better balance of performance (in comparison to purely optimising for one configuration as per the prior art). This, in turn, enables the advantages of having interchangeable wing tip devices to be more-fully realised.

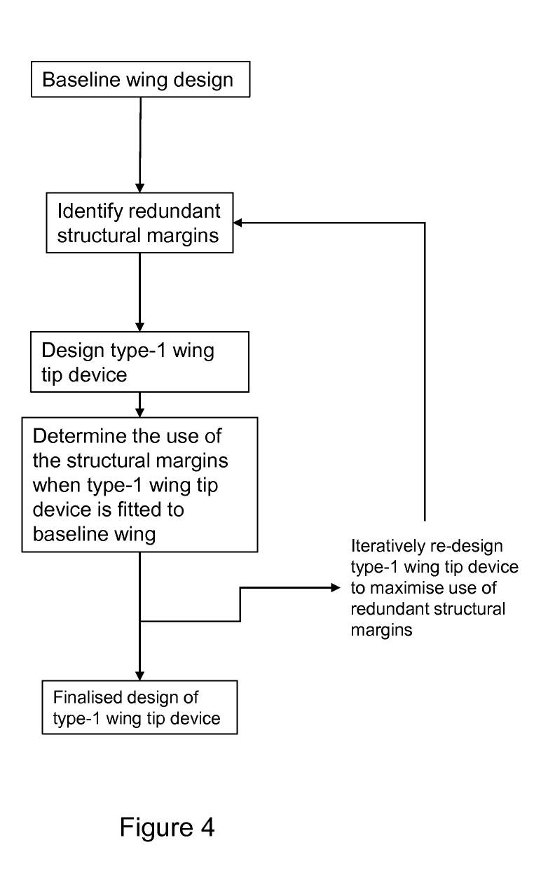

The first embodiment of the invention provides a wing that is designed for two different configurations of wing tip device. It has been recognised that it may also be desirable to provide a wing tip device that is designed for a particular wing. FIG. 4 is a flow-chart of a second embodiment of the invention, showing a novel method of how a wing tip device was designed. The method starts from a baseline wing design and the identification of redundant structural margins in that baseline wing (for example redundant structural capacity that has arisen due to the existence of other aircraft components and their influence on the wing structure). The method comprises the steps of iteratively designing the wing tip device such that when the wing tip device is attached to the wing, at least some of the redundant structural margins of the wing are used during flight of the aircraft. The second embodiment of the invention thus recognises that a wing may have redundant structural margins, and that those can be used by appropriately tailoring the wing tip design. For example in the second embodiment, the lift distribution and sweep of the wing tip device are tailored to make use of the otherwise redundant structural margins.

Whilst the present invention has been described and illustrated with reference to particular embodiments, it will be appreciated by those of ordinary skill in the art that the invention lends itself to many different variations not specifically illustrated herein. Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A method of designing a wing for an aircraft, the wing having a connection interface at its tip for receiving a plurality of different wing tip devices, and the wing being configurable between a first configuration in which a first wing tip device is connected to the connection interface, and a second configuration in which the first wing tip device is replaced by a second wing tip device connected to the connection interface,
wherein the method comprises the step of
designing the wing for performance in both the first configuration and the second configuration.

2. A method according to claim 1, wherein the step of designing the wing comprises designing for the aircraft flying a first mission profile in the first configuration, and for the aircraft flying a second mission profile in the second configuration.

3. An aircraft wing, the wing having a connection interface at the tip of the wing, and the wing being configurable between a first configuration in which a first wing tip device is connected to the connection interface, and a second configuration in which a second wing tip device is connected to the connection interface to replace the first wing tip device,
wherein the wing has been designed for performance in both the first and the second configurations.

4. An aircraft wing according to claim 3, wherein the wing is designed for use in the first configuration on an aircraft flying a first mission profile, and for use in the second configuration on the aircraft flying a second mission profile.

5. An aircraft wing according to claim 3, wherein the aerodynamic characteristics of the wing and the structural characteristics of the wing, have been designed for performance in both the first configuration and the second configuration.

6. A method of designing a wing tip device for an aircraft wing, the aircraft wing having redundant structural margins,
wherein the method comprises the steps of
designing the wing tip device such that when the wing tip device is attached to the wing, at least some of the redundant structural margins of the wing are used during flight of the aircraft.

7. The method according to claim 6, further comprising designing a wing for an aircraft, the wing having a connection interface at its tip for receiving a plurality of different wing tip devices, and the wing being configurable between a first configuration in which a first wing tip device is connected to the connection interface, and a second configuration in which the first wing tip device is replaced by a second wing tip device connected to the connection interface, wherein the method comprises the step of designing the wing for performance in both the first configuration and the second configuration, and wherein the method of designing of the wing and the method of designing the wing tip device, are used as part of an iterative design process.

8. The method according to claim 6, wherein the step of designing the wing tip device comprises
(i) calculating aerodynamic performance of an initial design of the wing tip device;
(ii) calculating the structural loads created by the wing tip device in use;
(iii) calculating the use of the redundant structural margins, by the loads in step (iii); and
(iv) iteratively repeating steps (i) to (iii) for variants of the initial design of wing tip device, until a final design of wing tip device is reached.

9. A method of preparing an aircraft for sale, the method comprising
(i) offering an aircraft for sale, the aircraft having a wing with a connection interface at the tip thereof;
(ii) offering a customer a plurality of different wing tip devices for connection to the connection interface, each wing tip device being designed for use in a respective mission profile; and
(iii) receiving a selection from the plurality of wing tip devices, from the customer.

10. A method according to claim 9, further comprising the step of (iv) connecting the selected wing tip device to the connection interface of the wing.

11. A method of providing increased functionality of an aircraft, the method comprising
having a wing of the aircraft configured in a first configuration in which a first wing tip device is connected to a connection interface at the tip of the wing, the first configuration being designed for use during a first mission profile,
identifying a second mission profile, and
modifying the wing to a second configuration in which the first wing tip device is replaced by a second wing tip device connected to the connection interface, the second configuration being designed for use during the second mission profile such that the performance of the wing is improved relative to its performance if it remained in the first configuration during the second mission profile.

12. An aircraft wing configurable between a first configuration for use during a first mission profile, and a second configuration for use during a second mission profile
wherein the wing has a connection interface at the tip of the wing and in the first configuration a first wing tip device, designed for use during the first mission profile, is connected to the connection interface,
and in the second configuration, the first wing tip device is replaced by a second wing tip device, designed for use during the second mission profile, connected to the connection interface.

13. An aircraft comprising the aircraft wing of claim 3.
